(19) United States
(12) Patent Application Publication
(10) Pub. No.: US 2025/0142188 A1
(43) Pub. Date: May 1, 2025

(54) OMNIDIRECTIONAL IMAGE CAPTURE APPARATUS ARCHITECTURE

(71) Applicant: GoPro, Inc., San Mateo, CA (US)

(72) Inventors: Nicholas Vitale, Foster City, CA (US); Adrian Santos, Lake Forest, CA (US); Akshay Shinde, Sunnyvale, CA (US); Herman Wong, Millbrae, CA (US)

(21) Appl. No.: 18/917,314

(22) Filed: Oct. 16, 2024

Related U.S. Application Data
(60) Provisional application No. 63/546,005, filed on Oct. 27, 2023.

(51) Int. Cl. H04N 23/51; H04N 23/54; H04N 23/55; H04N 23/698; H04N 23/90

(52) U.S. Cl. CPC H04N 23/51; H04N 23/54; H04N 23/55; H04N 23/90; H04N 23/698

(57) ABSTRACT

An image capture that includes: a front housing, which defines a front opening; a front mounting member that is located within the front opening; a front integrated sensor-lens assembly (ISLA) that is mechanically connected to, and which extends through, the front mounting member; a front internal heat sink that is connected to the front housing; a rear housing, which defines a rear opening, and is connected to the front housing so as to form a watertight seal therebetween; a rear mounting member that is located within the rear opening; a rear ISLA that extends through the rear mounting member such that the image capture apparatus is devoid of any direct connection between the rear mounting member and the rear ISLA; and a rear internal heat sink that is connected to the rear housing.

### CROSS-REFERENCE TO RELATED APPLICATION(S)

This application claims the benefit of and priority to U.S. Provisional Patent Application Ser. No. 63/546,005, filed Oct. 27, 2023, the entire contents of which are hereby incorporated by reference.

### TECHNICAL FIELD

The present disclosure relates to an architecture for an (omnidirectional, spherical) image capture apparatus that facilitates the insertion of various internal components into a front housing thereof in a single (e.g., forward, front) direction, as well as connection of the various internal components to the front housing.

### BACKGROUND

Image capture apparatuses are used in a variety of applications including, for example, handheld cameras and video recorders, cell phones, drones, vehicles, etc., and typically include one or more lenses (or other such optical elements), and one or more image sensors. The lens(es) capture content by receiving and focusing light, and the image sensor(s) convert the captured content into an electronic image signal that is processed by an image signal processor to generate an image. In some image capture apparatuses, the lens(es) and the image sensor(s) are integrated into a single unit, which is known as an integrated sensor-lens assembly (ISLA).

Omnidirectional (e.g., spherical) image capture apparatuses typically includes a pair of ISLAs that are oriented in opposite (e.g., front and rear) directions. The ISLAs define overlapping fields-of-view, which capture a pair of images that are stitched together during image processing so as to generate a single, combined 360 degree omnidirectional (spherical) image.

In addition to the ISLAs, omnidirectional image capture apparatuses include an array of internal components, both structural and electrical, that require precise placement and alignment, which results in a cumbersome and complex assembly process. As such, an opportunity exists to improve not only the assembly of omnidirectional image capture apparatuses, but product packaging, which is addressed by the present disclosure by providing an architecture that not only simplifies assembly but also contributes to a reduction in the overall form factor of the image capture apparatus.

### SUMMARY

In one aspect of the present disclosure, an image capture apparatus is disclosed that includes: a front housing, which defines a front opening, and a front window that is spaced vertically from the front opening; a front mounting member that is connected to the front housing, and which is located within the front opening; a front ISLA that extends through the front mounting member, and which is mechanically connected thereto; a rear housing that defines a rear opening, and a relief that is spaced vertically from the rear opening; a rear mounting member that is connected to the rear housing, and which is located within the rear opening; and a rear ISLA that extends through the rear mounting member such that the image capture apparatus is devoid of any direct connection between the rear mounting member and the rear ISLA.

The front housing includes: an antenna mount that is configured for connection to a first antenna; a first locating member that is configured for engagement with the first antenna to guide the first antenna during connection to the front housing; a pocket that is configured to receive a second antenna; a second locating member that is configured for engagement with the second antenna to guide the second antenna during connection to the front housing; a speaker assembly that is connected to an inner side wall of the front housing; at least one alignment member; and at least one boss. The speaker assembly includes a speaker, and a mounting bracket, wherein the mounting bracket defines at least one aperture, and at least one opening that is configured to receive at least one mechanical fastener. The at least one alignment member is configured for insertion into the at least one aperture in the mounting bracket to guide the mounting bracket during connection of the speaker assembly to the front housing, and the at least one boss is configured to receive the at least one mechanical fastener to thereby connect the speaker assembly to the front housing.

The rear housing is connected to the front housing so as to form a watertight seal therebetween.

In certain embodiments, the front mounting member may be adhesively connected to the front housing.

In certain embodiments, the rear mounting member may be adhesively connected to the rear housing.

In certain embodiments, the image capture apparatus may further include a front internal heat sink that is connected to the front housing, and a rear internal heat sink that is connected to the rear housing.

In certain embodiments, the front internal heat sink may be heat staked to the front housing.

In certain embodiments, the rear internal heat sink may be heat staked to the rear housing.

In certain embodiments, the image capture apparatus may further include mechanical fasteners that extend through the front housing, through the front internal heat sink, and into threaded engagement with the rear internal heat sink.

In another aspect of the present disclosure, an image capture apparatus is disclosed that includes: a front housing, which defines a front opening; a front mounting member that is located within the front opening; a front ISLA that is mechanically connected to, and which extends through, the front mounting member; a front internal heat sink that is connected to the front housing; a rear housing, which defines a rear opening, and is connected to the front housing so as to form a watertight seal therebetween; a rear mounting member that is located within the rear opening; a rear ISLA that extends through the rear mounting member such that the image capture apparatus is devoid of any direct connection between the rear mounting member and the rear ISLA; and a rear internal heat sink that is connected to the rear housing.

In certain embodiments, the front mounting member may be adhesively connected to the front housing.

In certain embodiments, the rear mounting member may be adhesively connected to the rear housing.

In certain embodiments, the front ISLA may include a front seal that is configured for engagement with the front mounting member to inhibit water and/or debris from entering the image capture apparatus through the front housing and/or through the front mounting member.

In certain embodiments, the rear ISLA may include a rear seal that is configured for engagement with the rear mounting member to inhibit water and/or debris from entering the image capture apparatus through the rear housing and/or through the rear mounting member.

In certain embodiments, the image capture apparatus may further include a speaker assembly that is connected to an inner side wall of the front housing.

In certain embodiments, the speaker assembly may include a speaker, and a mounting bracket that supports the speaker.

In certain embodiments, the front housing may include at least one alignment member that extends from the inner side wall, and which is configured for insertion into the mounting bracket to guide the speaker assembly during connection to the front housing, and at least one boss that extends from the inner side wall, and which is configured to receive at least one mechanical fastener such that the at least one mechanical fastener extends through the mounting bracket and into the at least one boss to thereby connect the speaker assembly to the front housing.

In certain embodiments, the front internal heat sink and the rear internal heat sink may be mechanically connected to the front housing.

In certain embodiments, the front internal heat sink may include first apertures, the rear internal heat sink may include second apertures, and the front housing may include third apertures, wherein the first apertures, the second apertures, and the third apertures are configured to receive mechanical fasteners such that the mechanical fasteners extend through the front housing, through the front internal heat sink, and into threaded engagement with the rear internal heat sink.

In certain embodiments, the image capture apparatus may further include an interconnect mechanism that is configured for engagement with an accessory to thereby connect the image capture apparatus to the accessory.

In certain embodiments, the first apertures, the second apertures, and the third apertures may be spaced laterally outward of the interconnect mechanism.

In another aspect of the present disclosure, a method of assembling an image capture apparatus is disclosed. The image capture apparatus includes a front housing having an inner side wall and an antenna mount and a pocket associated with the inner side wall, and the method includes: inserting an operational button into a receptacle that extends into the inner side wall, wherein the receptacle is positioned between the antenna mount and the pocket; connecting a speaker assembly to the inner side wall; connecting a front mounting member to the front housing; positioning a front ISLA within the front mounting member; connecting a rear mounting member to a rear housing of the image capture apparatus; positioning a rear ISLA within the rear mounting member; and adhesively connecting the front housing and the rear housing so as to form a watertight seal therebetween, wherein the antenna mount is configured for connection to a first antenna, and the pocket is configured to receive a second antenna such that the second antenna is positioned vertically below the first antenna.

In certain embodiments, connecting the speaker assembly to the inner side wall may include inserting at least one alignment member that extends laterally inward from the inner side wall into at least one aperture defined by a mounting bracket of the speaker assembly, and inserting at least one mechanical fastener through at least one opening in the mounting bracket and into at least one boss on the inner side wall.

In certain embodiments, the method may further include connecting a front internal heat sink to the front housing, and connecting a rear internal heat sink to the rear housing.

In certain embodiments, connecting the front internal heat sink to the front housing may include heat staking the front internal heat sink to the front housing.

In certain embodiments, connecting the rear internal heat sink to the rear housing may include heat staking the rear internal heat sink to the rear housing.

In certain embodiments, the method may further include: inserting mechanical fasteners through the front housing, through the front internal heat sink, and into threaded engagement with the rear internal heat sink to thereby mechanically connect the front internal heat sink and the rear internal heat sink to the front housing.

### BRIEF DESCRIPTION OF THE DRAWINGS

The present disclosure is best understood from the following detailed description when read in conjunction with the accompanying drawings. According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIG. 4 is a block diagram of electronic components of an image capture apparatus.

FIG. 5 is a front, perspective view of an example of an (omnidirectional, spherical) image capture apparatus.

FIG. 6 is a rear, perspective view of the image capture apparatus seen in FIG. 5.

FIG. 7 is a cross-sectional view taken along line 7-7 in FIG. 5.

FIG. 8 is a front, perspective view of the image capture apparatus seen in FIG. 5 shown with parts separated.

FIG. 9 is a rear, perspective view of the image capture apparatus seen in FIG. 5 with a rear housing removed.

FIG. 10 is a rear, perspective view of a front housing of the image capture apparatus seen in FIG. 5.

FIG. 11 is a bottom, perspective view of the image capture apparatus seen in FIG. 5.

FIG. 12 is a front perspective view of the image capture apparatus seen in FIG. 5 shown in phantom and illustrating various seals.

FIG. 13 is a rear perspective view of the image capture apparatus seen in FIG. 5 shown in phantom and illustrating additional seals.

FIG. 14 is a rear, perspective view of the rear housing of the image capture apparatus seen in FIG. 5.

FIG. 15 is a front, perspective view of the rear housing shown with a rear internal heat sink.

FIG. 16 is a front, perspective view of the rear housing with the rear internal heat sink removed.

FIG. 17 is a rear, perspective view of a front internal heat sink of the image capture apparatus seen in FIG. 5.

FIG. 18 is a front, perspective view of the rear internal heat sink.

FIG. 19 is an enlargement of the area of detail identified in FIG. 7.

FIG. 20 is a front, perspective view of the front internal heat sink illustrating sealing to the front housing.

FIG. 21 is a rear, perspective view of the front housing illustrating sealing to the front internal heat sink.

FIG. 22 is a rear, perspective view of the image capture apparatus seen in FIG. 5 shown in phantom and illustrating various seals.

### DETAILED DESCRIPTION

The present disclosure describes an image capture apparatus that includes a front housing with an architecture that simplifies the assembly process and contributes to a reduction in the overall form factor, which allows for improved mounting schemes, and supports mounting of the image capture apparatus to an increased variety of accessories.

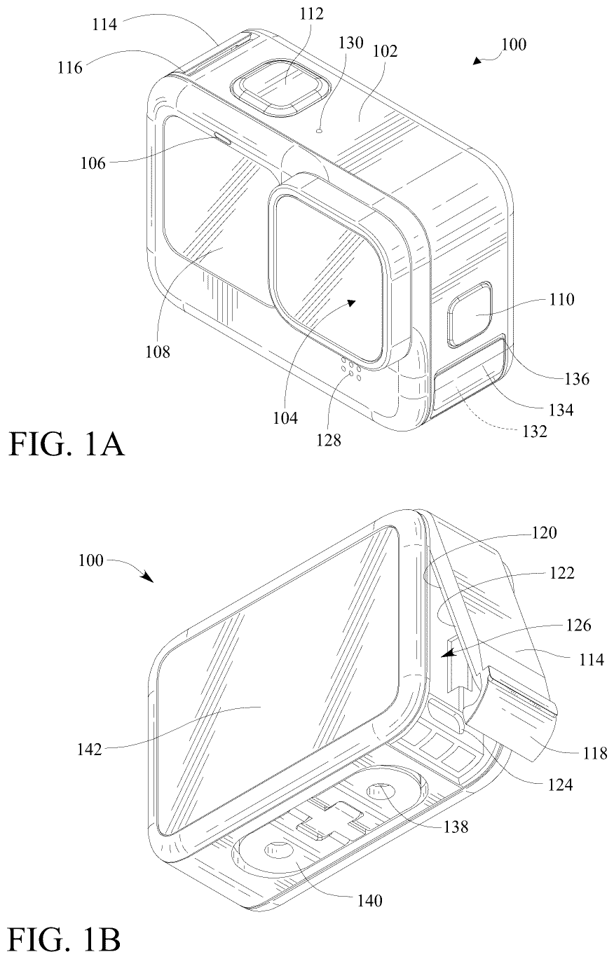

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-B, the image capture apparatus 100 includes internal electronics, such as imaging electronics, power electronics, and the like, internal to the body 102 for capturing images and performing other functions of the image capture apparatus 100. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be connected (secured) to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptable 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is positioned (located) behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects (secures) the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

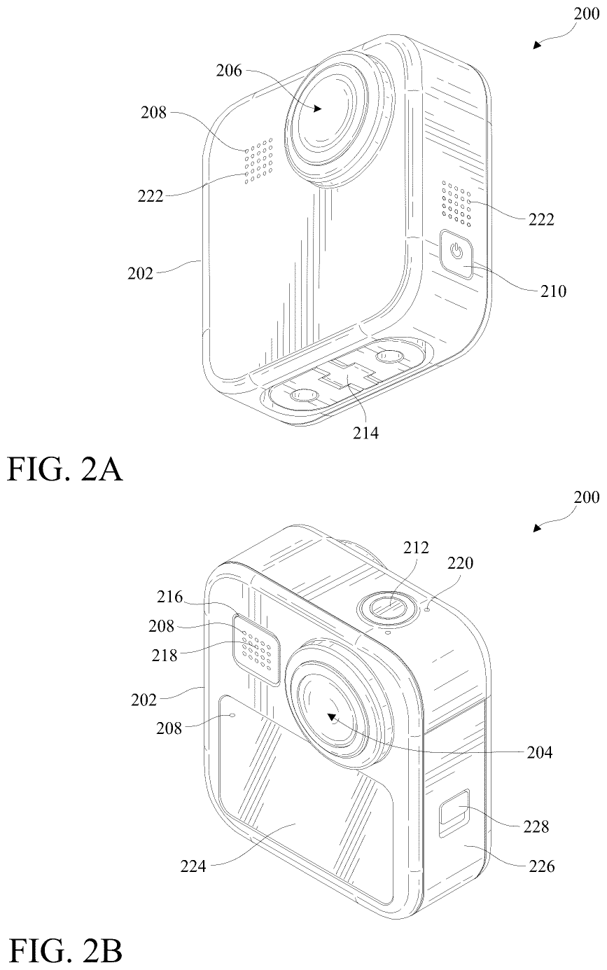

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

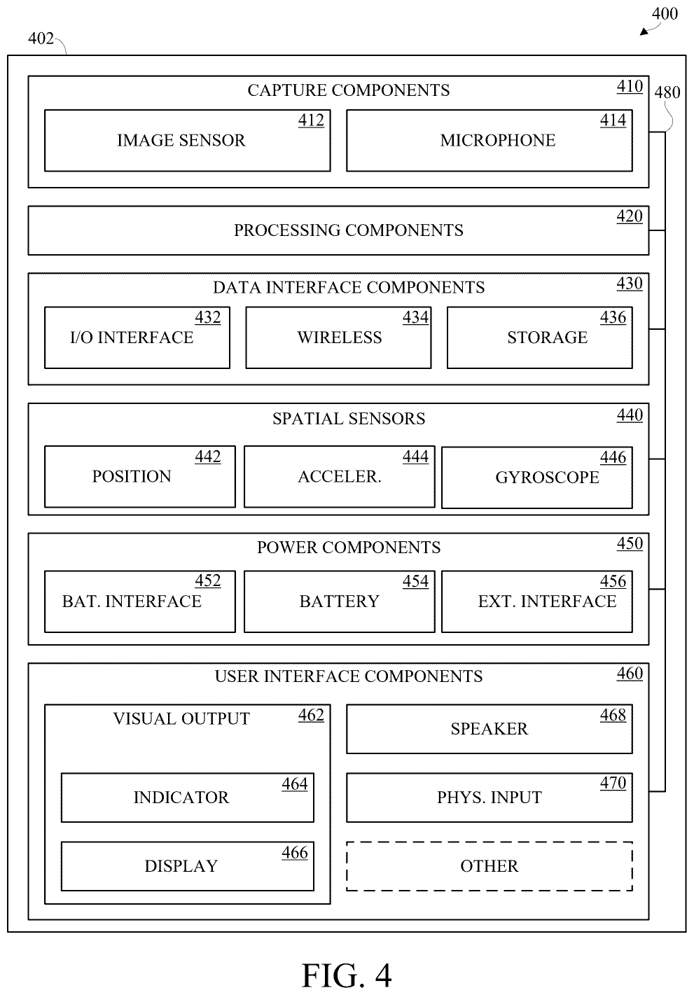

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 4.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is positioned (located) on a front surface of the body 202, a second audio component 220 is positioned (located) on a top surface of the body 202, and a third audio component 222 is positioned (located) on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

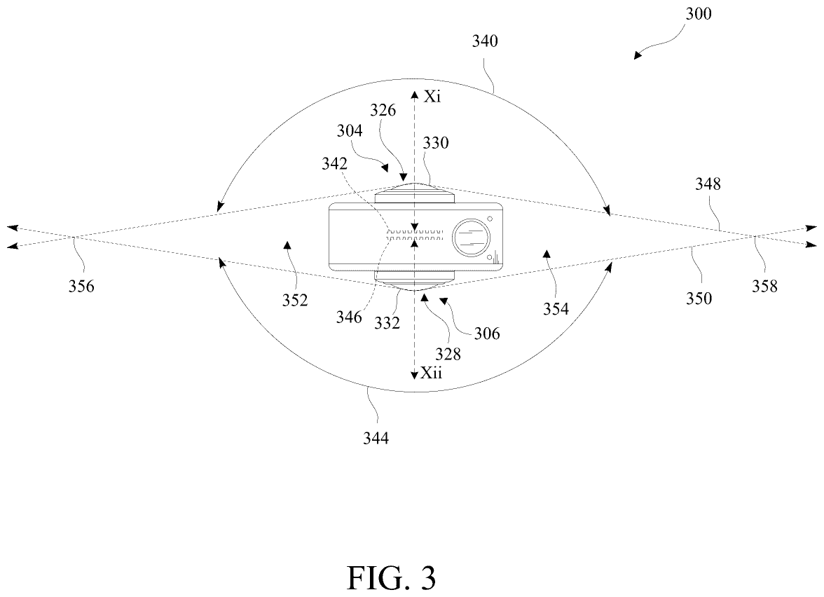

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342. In the illustrated embodiment, the first lens 330 and the first image sensor 342 are integrated into a single unit, whereby the first image capture device 304 is configured as a first ISLA 326 that defines a first optical axis Xi.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346. In the illustrated embodiment, the second lens 332 and the second image sensor 346 are integrated into a single unit, whereby the second image capture device 306 is configured as a second ISLA 328 that defines a second optical axis Xii.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions (e.g., a forward direction and a rearward direction), and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The ISLAs 326, 328 (e.g., the lenses 330, 332) may be aligned as shown (e.g., such that the optical axes Xi, Xii are coincident with each other), laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

FIG. 4 is a block diagram of electronic components in an image capture apparatus 400. The image capture apparatus 400 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-B, the image capture apparatus 200 shown in FIGS. 2A-B, or the image capture apparatus 300 shown in FIG. 3, may be implemented as shown in FIG. 4.

The image capture apparatus 400 includes a body 402. The body 402 may be similar to the body 102 shown in FIGS. 1A-1B or the body 202 shown in FIGS. 2A-2B. The body 402 includes electronic components such as capture components 410, processing components 420, data interface components 430, spatial sensors 440, power components 450, user interface components 460, and a bus 480.

The capture components 410 include an image sensor 412 for capturing images. Although one image sensor 412 is shown in FIG. 4, the capture components 410 may include multiple image sensors. The image sensor 412 may be similar to the image sensors 342, 346 shown in FIG. 3. The image sensor 412 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 412 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 412 captures detected light as image data and conveys the captured image data as electrical signals (image signals or image data) to the other components of the image capture apparatus 400, such as to the processing components 420, such as via the bus 480.

The capture components 410 include a microphone 414 for capturing audio. Although one microphone 414 is shown in FIG. 4, the capture components 410 may include multiple microphones. The microphone 414 detects and captures, or records, sound, such as sound waves incident upon the microphone 414. The microphone 414 may detect, capture, or record sound in conjunction with capturing images by the image sensor 412. The microphone 414 may detect sound to receive audible commands to control the image capture apparatus 400. The microphone 414 may be similar to the microphones 128, 130, 132 shown in FIGS. 1A-1B or the audio components 218, 220, 222 shown in FIGS. 2A-2B.

The processing components 420 perform image signal processing, such as filtering, tone mapping, or stitching, to generate, or obtain, processed images, or processed image data, based on image data obtained from the image sensor 412. The processing components 420 may include one or more processors having single or multiple processing cores. In some implementations, the processing components 420 may include, or may be, an application specific integrated circuit (ASIC) or a digital signal processor (DSP). For example, the processing components 420 may include a custom image signal processor. The processing components 420 conveys data, such as processed image data, with other components of the image capture apparatus 400 via the bus 480. In some implementations, the processing components 420 may include an encoder, such as an image or video encoder that may encode, decode, or both, the image data, such as for compression coding, transcoding, or a combination thereof.

Although not shown expressly in FIG. 4, the processing components 420 may include memory, such as a random-access memory (RAM) device, which may be non-transitory computer-readable memory. The memory of the processing components 420 may include executable instructions and data that can be accessed by the processing components 420.

The data interface components 430 communicates with other, such as external, electronic devices, such as a remote control, a smartphone, a tablet computer, a laptop computer, a desktop computer, or an external computer storage device. For example, the data interface components 430 may receive commands to operate the image capture apparatus 400. In another example, the data interface components 430 may transmit image data to transfer the image data to other electronic devices. The data interface components 430 may be configured for wired communication, wireless communication, or both. As shown, the data interface components 430 include an I/O interface 432, a wireless data interface 434, and a storage interface 436. In some implementations, one or more of the I/O interface 432, the wireless data interface 434, or the storage interface 436 may be omitted or combined.

The I/O interface 432 may send, receive, or both, wired electronic communications signals. For example, the I/O interface 432 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 432 is shown in FIG. 4, the data interface components 430 include multiple I/O interfaces. The I/O interface 432 may be similar to the data interface 124 shown in FIG. 1B.

The wireless data interface 434 may send, receive, or both, wireless electronic communications signals. The wireless data interface 434 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 434 is shown in FIG. 4, the data interface components 430 include multiple wireless data interfaces. The wireless data interface 434 may be similar to the data interface 124 shown in FIG. 1B.

The storage interface 436 may include a memory card connector, such as a memory card receptacle, configured to receive and operatively couple to a removable storage device, such as a memory card, and to transfer, such as read, write, or both, data between the image capture apparatus 400 and the memory card, such as for storing images, recorded audio, or both captured by the image capture apparatus 400 on the memory card. Although one storage interface 436 is shown in FIG. 4, the data interface components 430 include multiple storage interfaces. The storage interface 436 may be similar to the data interface 124 shown in FIG. 1B.

The spatial, or spatiotemporal, sensors 440 detect the spatial position, movement, or both, of the image capture apparatus 400. As shown in FIG. 4, the spatial sensors 440 include a position sensor 442, an accelerometer 444, and a gyroscope 446. The position sensor 442, which may be a global positioning system (GPS) sensor, may determine a geospatial position of the image capture apparatus 400, which may include obtaining, such as by receiving, temporal data, such as via a GPS signal. The accelerometer 444, which may be a three-axis accelerometer, may measure linear motion, linear acceleration, or both of the image capture apparatus 400. The gyroscope 446, which may be a three-axis gyroscope, may measure rotational motion, such as a rate of rotation, of the image capture apparatus 400. In some implementations, the spatial sensors 440 may include other types of spatial sensors. In some implementations, one or more of the position sensor 442, the accelerometer 444, and the gyroscope 446 may be omitted or combined.

The power components 450 distribute electrical power to the components of the image capture apparatus 400 for operating the image capture apparatus 400. As shown in FIG. 4, the power components 450 include a battery interface 452, a battery 454, and an external power interface 456 (ext. interface). The battery interface 452 (bat. interface) operatively couples to the battery 454, such as via conductive contacts to transfer power from the battery 454 to the other electronic components of the image capture apparatus 400. The battery interface 452 may be similar to the battery receptacle 126 shown in FIG. 1B. The external power interface 456 obtains or receives power from an external source, such as a wall plug or external battery, and distributes the power to the components of the image capture apparatus 400, which may include distributing power to the battery 454 via the battery interface 452 to charge the battery 454. Although one battery interface 452, one battery 454, and one external power interface 456 are shown in FIG. 4, any number of battery interfaces, batteries, and external power interfaces may be used. In some implementations, one or more of the battery interface 452, the battery 454, and the external power interface 456 may be omitted or combined. For example, in some implementations, the external interface 456 and the I/O interface 432 may be combined.

The user interface components 460 receive input, such as user input, from a user of the image capture apparatus 400, output, such as display or present, information to a user, or both receive input and output information, such as in accordance with user interaction with the image capture apparatus 400.

As shown in FIG. 4, the user interface components 460 include visual output components 462 to visually communicate information, such as to present captured images. As shown, the visual output components 462 include an indicator 464 and a display 466. The indicator 464 may be similar to the indicator 106 shown in FIG. 1A or the indicators 208 shown in FIGS. 2A-2B. The display 466 may be similar to the display 108 shown in FIG. 1A, the display 142 shown in FIG. 1B, or the display 224 shown in FIG. 2B. Although the visual output components 462 are shown in FIG. 4 as including one indicator 464, the visual output components 462 may include multiple indicators. Although the visual output components 462 are shown in FIG. 4 as including one display 466, the visual output components 462 may include multiple displays. In some implementations, one or more of the indicators 464 or the display 466 may be omitted or combined.

As shown in FIG. 4, the user interface components 460 include a speaker 468. The speaker 468 may be similar to the speaker 138 shown in FIG. 1B or the audio components 218, 220, 222 shown in FIGS. 2A-2B. Although one speaker 468 is shown in FIG. 4, the user interface components 460 may include multiple speakers. In some implementations, the speaker 468 may be omitted or combined with another component of the image capture apparatus 400, such as the microphone 414.

As shown in FIG. 4, the user interface components 460 include a physical input interface 470. The physical input interface 470 may be similar to the mode buttons 110, 210 shown in FIGS. 1A, 2A or the shutter buttons 112, 212 shown in FIGS. 1A, 2B. Although one physical input interface 470 is shown in FIG. 4, the user interface components 460 may include multiple physical input interfaces. In some implementations, the physical input interface 470 may be omitted or combined with another component of the image capture apparatus 400. The physical input interface 470 may be, for example, a button, a toggle, a switch, a dial, or a slider.

As shown in FIG. 4, the user interface components 460 include a broken line border box labeled “other” to indicate that components of the image capture apparatus 400 other than the components expressly shown as included in the user interface components 460 may be user interface components. For example, the microphone 414 may receive, or capture, and process audio signals to obtain input data, such as user input data corresponding to voice commands. In another example, the image sensor 412 may receive, or capture, and process image data to obtain input data, such as user input data corresponding to visible gesture commands. In another example, one or more of the spatial sensors 440, such as a combination of the accelerometer 444 and the gyroscope 446, may receive, or capture, and process motion data to obtain input data, such as user input data corresponding to motion gesture commands.

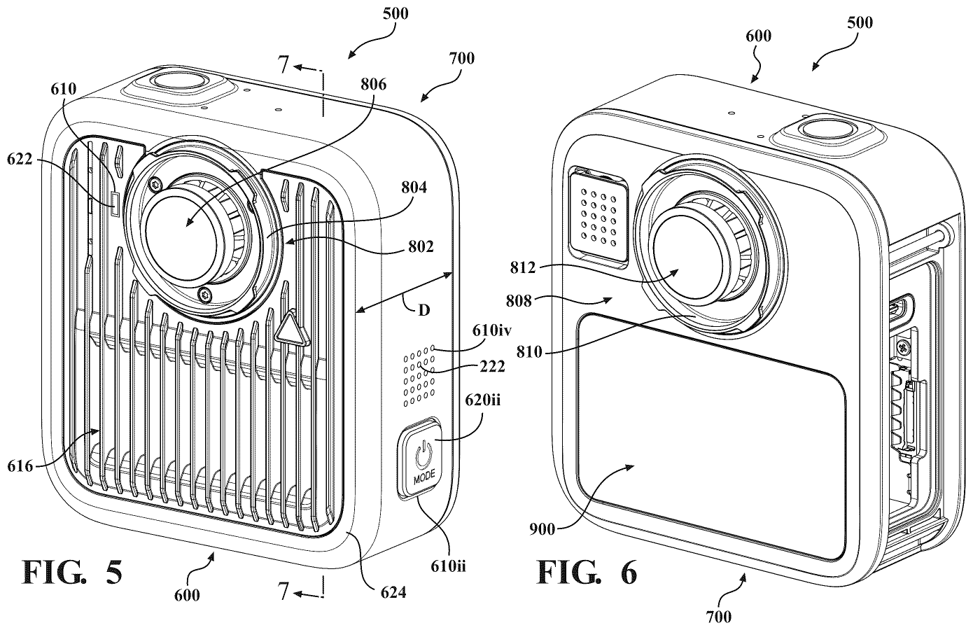

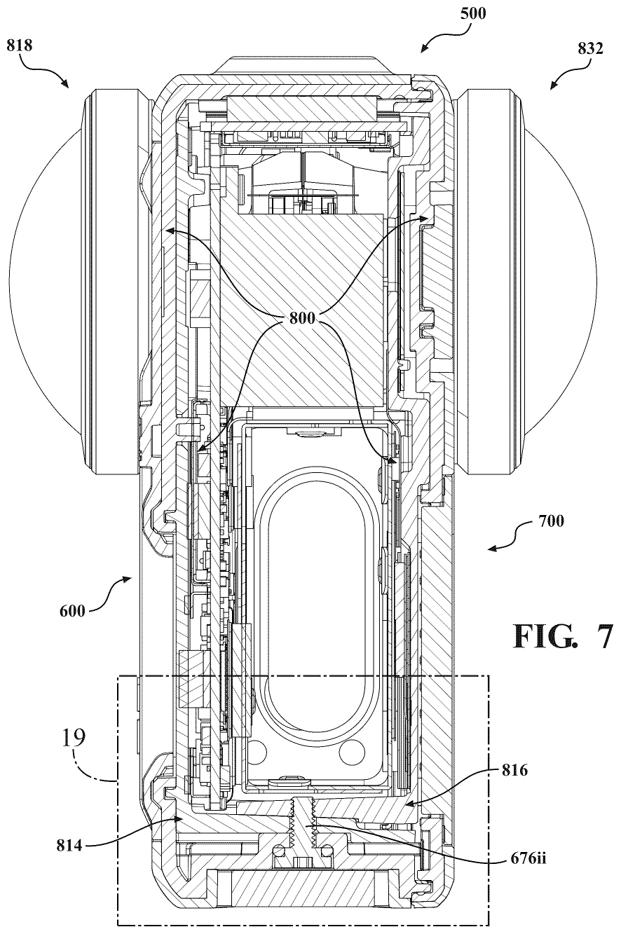

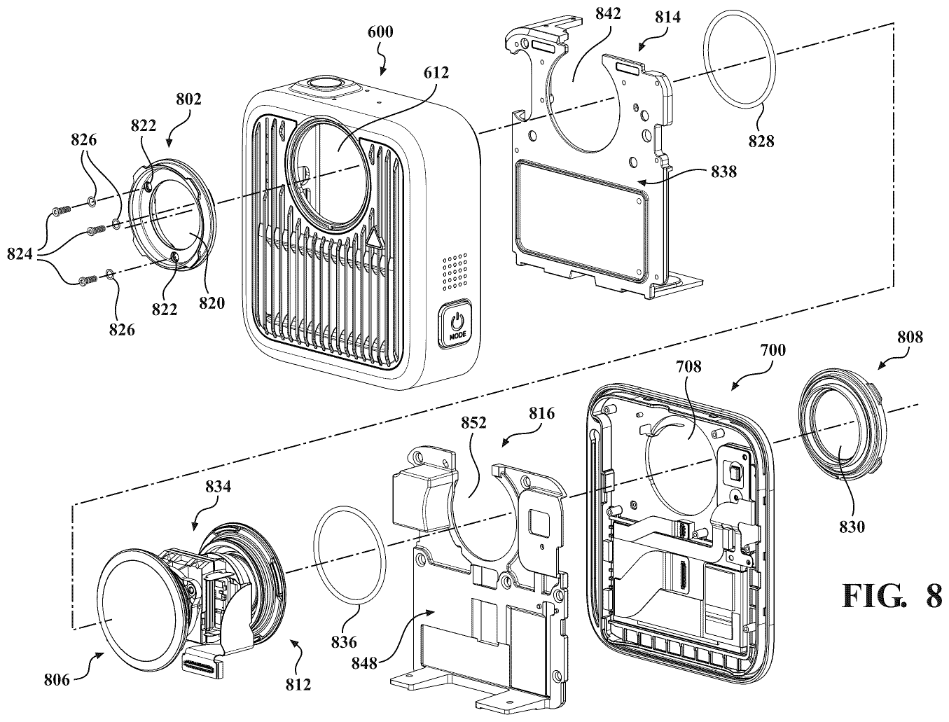

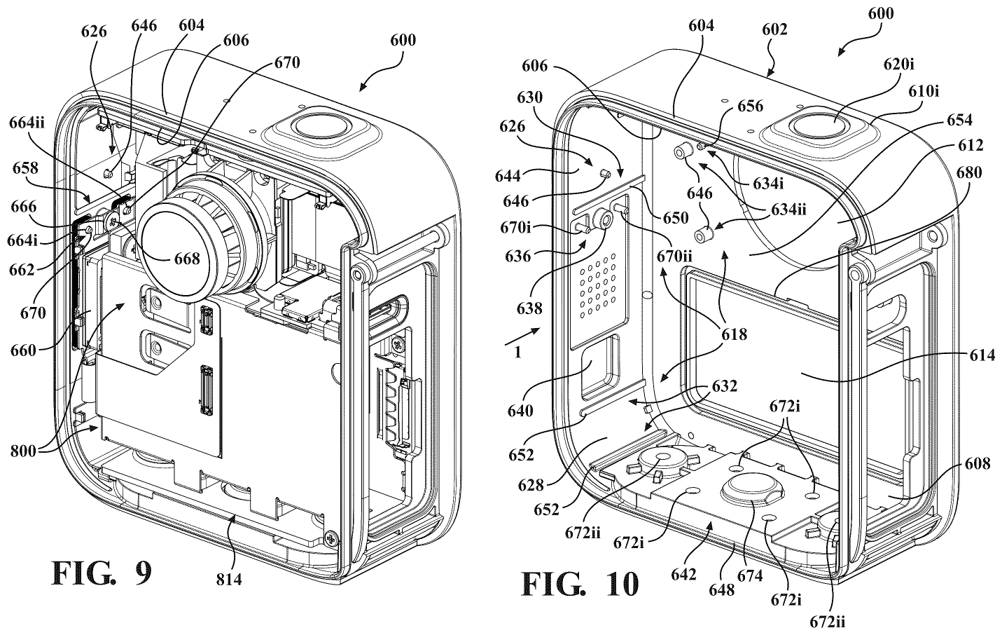

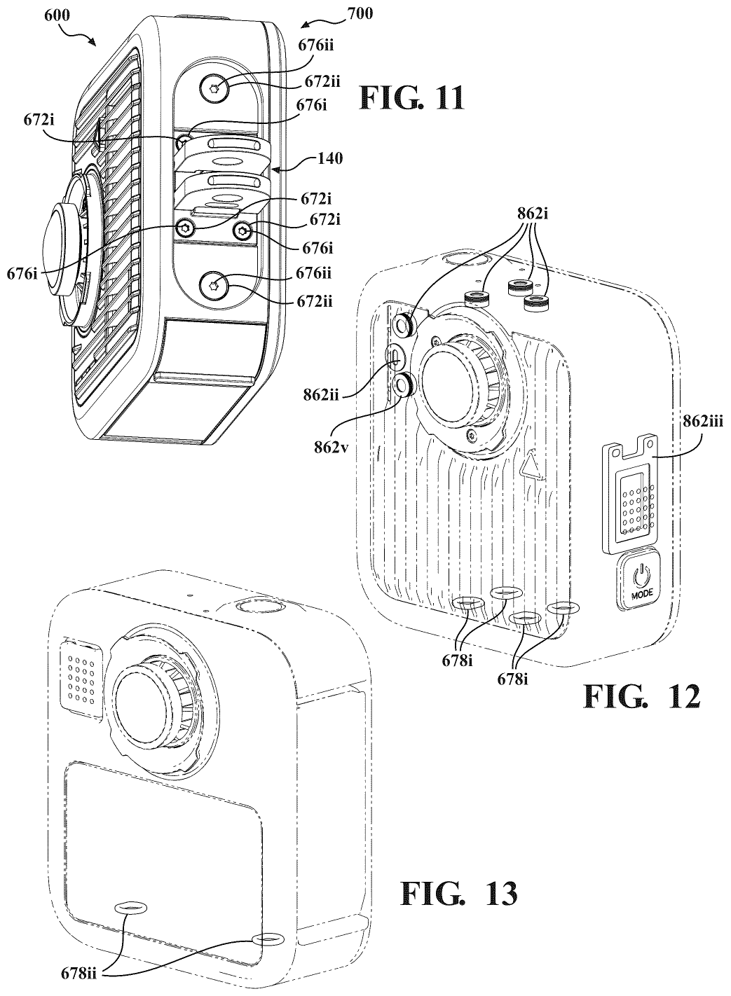

With reference now to FIGS. 5-13, an (omnidirectional, spherical) image capture apparatus 500 is illustrated, which includes features similar to the aforedescribed image capture apparatus 300, and, accordingly, will only be discussed with respect to differences therefrom in the interest of brevity. The image capture apparatus 500 includes: a front housing 600 (e.g., a bucket 602); a rear housing 700; and a variety of internal components 800, both structural and electrical. As described in detail below, the internal components 800 of the image capture apparatus 500 include: a front (first) mounting member 802 (e.g., a front (first) bayonet 804), which is connected (secured) to the front housing 600; a front (first) integrated sensor-lens assembly (ISLA) 806, which includes features similar to the aforedescribed ISLA 326 (FIG. 3); a rear (second) mounting member 808 (e.g., a rear (second) bayonet 810), which is connected (secured) to the rear housing 700; a rear (second) ISLA 812, which includes features similar to the aforedescribed ISLA 328 (FIG. 3); a front (first) internal heat sink 814; and a rear (second) internal heat sink 816. More specifically, FIG. 5 is a front, perspective view of the image capture apparatus 500; FIG. 6 is a rear, perspective view of the image capture apparatus 500; FIG. 7 is a cross-sectional view taken along line 7-7 in FIG. 5; FIG. 8 is a front, perspective view of the image capture apparatus 500 shown with parts separated; FIG. 9 is a rear, perspective view of the image capture apparatus 500 with the rear housing 700 removed; FIG. 10 is a rear, perspective view of the front housing 600; FIG. 11 is a bottom, perspective view of the image capture apparatus 500; and FIGS. 12 and 13 are respective front and rear perspective views of the image capture apparatus 500 shown in phantom and illustrating sealing of the image capture apparatus 500.

The front housing 600 includes an architecture that provides a framework for various components of the image capture apparatus 500 including, for example, the front mounting member 802, the front ISLA 806, and the front internal heat sink 814, which itself provides a framework for various components, electronics, and circuitry that support operability and functionality of the image capture apparatus 500. As described in detail below, the framework provided by the architecture of the front housing 600 simplifies assembly of the image capture apparatus 500 by focusing the area where connections are to be made and reducing (if not entirely eliminating) blind steps, which improves visibility and facilitates more precise alignment (positioning) of the components.

The front housing 600 defines a planar shelf 604 (FIGS. 9, 10) and a tongue 606 that extend around (e.g., adjacent to) a rear perimeter thereof. The planar shelf 604 defines a seat for the rear housing 700 to facilitate proper alignment (positioning) of the rear housing 700 in relation to the front housing 600, which further enhances the overall fit and finish of the image capture apparatus 500 upon assembly. The tongue 606 projects (extends) rearwardly (i.e., toward the rear housing 700) and is configured to interface with a corresponding structure on the rear housing 700 to facilitate (sealed) engagement of the housings 600, 700 upon assembly of the image capture apparatus 500, as described in further detail below.

The front housing 600 defines: an internal compartment 608 (FIG. 10), which receives (accommodates) the internal components 800 of the image capture apparatus 500; a plurality (series) of apertures 610; a front opening 612; and a front window 614. Additionally, the front housing 600 includes: an external heat sink 616, and a variety of internal support structures 618 that facilitate assembly of the image capture apparatus 500.

The apertures 610 are configured to receive (accommodate) various buttons, displays, etc., on the image capture apparatus 500. In the particular embodiment illustrated, the front housing 600 includes: a (first) aperture 610i, which is configured to receive a (first) operational button 620i (e.g., a shutter button); a (second) aperture 610ii, which is configured to receive a (second) operational button 620ii (e.g., a mode button); a (third) aperture 610iii, which is configured to receive a light pipe 622 (e.g., a status indicator or the like); and a (fourth) aperture 610iv, which is configured a (microphone) port for the audio component 222). It should be appreciated, however, that the particular number of apertures 610, operational buttons 620, and light pipes 622 may be altered in various embodiments without departing from the scope of the present disclosure. As such, embodiments of the image capture apparatus 500 including both greater and fewer numbers of apertures 610, operational buttons 620, and light pipes 622 are also envisioned herein, and would not be beyond the scope of the present disclosure.

The front opening 612 extends through the front housing 600, and is configured to receive the front mounting member 802. More specifically, the front mounting member 802 is adhesively connected (secured) to the front housing 600 within the front opening 612, which obviates the need for any mechanical connection therebetween.

The front window 614 is spaced vertically from the front opening 612, and is positioned (located) inwardly of (e.g., behind) the external heat sink 616 (FIG. 5). The front window 614 extends through the front housing 600, and allows heat (e.g., from the front internal heat sink 814) to vent (flow) through the front housing 600, thereby improving thermal distribution and heat dissipation. Although shown as being generally rectangular in configuration, it should be appreciated that the front window 614 may include any configuration suitable for the intended purpose of facilitating air flow through the front housing 600 in order to improve thermal distribution and heat dissipation in the manner described herein.

The external heat sink 616 is connected (secured) to an outer face 624 of the front housing 600 (e.g., via an adhesive), and increases heat dissipation in order to improve operation (e.g., increase the run time) of the image capture apparatus 500. Thus, in the illustrated embodiment, the front housing 600 and the external heat sink 616 are configured as discrete (separate) components of the image capture apparatus 500. Embodiments in which the front housing 600 and the external heat sink 616 may be integrally (monolithically, unitarily) formed (i.e., such that the front housing 600 and the external heat sink 616 are formed from a single piece of the material) are also envisioned herein, however, as are embodiments in which the external heat sink 616 may be mechanically connected to the front housing 600 via (one or more) at least one mechanical fastener (e.g., screw(s), pin(s), rivet(s), etc.), and would not be beyond the scope of the present disclosure.

With reference now to FIG. 10 in particular, the internal support structures 618 will be discussed, which include: an antenna mount 626; pocket 628; (one or more) at least one (first) locating member 630; (one or more) at least one (second) locating member 632; a plurality (series) of guides 634; (one or more) at least one alignment member 636; (one or more) at least one boss 638; a receptacle 640; and a mount 642.

The antenna mount 626 and the pocket 628 are each associated with an inner side wall 644 of the front housing 600. More specifically, in the illustrated embodiment, the antenna mount 626 is configured as a heat stake 646 that extends laterally inward from the inner side wall 644 (e.g., in generally orthogonal relation to the optical axes Xi, Xii (FIG. 3)), and the pocket 628 is defined by the inner side wall 644 at (e.g., adjacent to) a bottom wall 648 of the front housing 600. The antenna mount 626 supports and facilitates the connection of a first antenna (not shown) to the front housing 600, and the pocket 628 receives and facilitates the connection of a second antenna (not shown) to the front housing 600 such that the second antenna is positioned (located) vertically below the first antenna, wherein the first and second antennas collectively support various wireless communication capabilities of the image capture apparatus 500 (e.g., WiFi, Bluetooth, etc.). More specifically, in the illustrated embodiment, the second antenna is adhesively connected (secured) to the front housing 600 within the pocket 628 (e.g., via double-sided tape).

The locating member(s) 630 are positioned (located) vertically below the antenna mount 626, and extend laterally inward from the inner side wall 644 of the front housing 600. More specifically, in the illustrated embodiment, the locating member(s) 630 include rib(s) 650 that are configured for engagement (contact) with the first antenna (not shown) to guide the first antenna during connection to the front housing 600.

Although shown as including a single locating member 630, it should be appreciated that the particular number of locating members 630 may be altered in various embodiments without departing from the scope of the present disclosure. As such, embodiments of the front housing 600 including a greater number of locating members 630 (e.g., two or more) are also envisioned herein, and would not be beyond the scope of the present disclosure.

The locating member(s) 632 are positioned (located) adjacent to the pocket 628, and extend laterally inward from the inner side wall 644 of the front housing 600. More specifically, in the illustrated embodiment, the locating member(s) 632 includes struts 652 that are positioned (located) on opposite sides of (e.g., vertically above and vertically below) the pocket 628, and which are configured for engagement (contact) with the second antenna (not shown) to guide the second antenna during connection to the front housing 600.

Although shown as including a pair of locating members 632, it should be appreciated that the particular number of locating members 632 may be altered in various embodiments without departing from the scope of the present disclosure. As such, embodiments of the front housing 600 including both greater and fewer numbers of locating members 632 are also envisioned herein, and would not be beyond the scope of the present disclosure.

As seen in FIG. 10, the locating members 630, 632 are oriented along a depth D (FIG. 5) of the image capture apparatus 500, and extend in generally orthogonal relation to the optical axes Xi, Xii (FIG. 3). Orientation of the locating members 630, 632 along the depth D of the image capture apparatus 500 facilitates insertion of the first and second antennas in a forward (front) direction 1 (FIG. 10) (e.g., away from the rear housing 700).

The guides 634 extend inwardly from an inner face 654 of the front housing 600 (e.g., in generally parallel relation to the optical axes Xi, Xii (FIG. 3)), and are configured for engagement with the front internal heat sink 814 (FIGS. 7-9, 17) in order to support proper alignment (positioning) thereof within the front housing 600, as described in further detail below. More specifically, the guides 634 include (one or more) at least one (first) guide 634i, which is configured as a pin 656, and a plurality (series) of (second) guides 634ii, which are configured as heat stakes 646.

Although shown as including a single pin 656, it should be appreciated that the particular number of pins 656 may be altered in various embodiments without departing from the scope of the present disclosure. As such, embodiments of the front housing 600 including a greater number of pins 656 (e.g., two or more) are also envisioned herein, and would not be beyond the scope of the present disclosure.

As seen in FIG. 10, the guides 634 are oriented along the depth D (FIG. 5) of the image capture apparatus 500 and extend in generally parallel relation to the locating members 630, 632 which facilitates insertion of the front internal heat sink 814 in the forward direction 1.

The alignment member(s) 636 and the boss(es) 638 collectively support a speaker assembly 658 and facilitate connection of the speaker assembly 658 to the front housing 600 (e.g., to the inner side wall 644). As seen in FIG. 9, the speaker assembly 658 includes a speaker 660, and a mounting bracket 662 that supports the speaker 660. The mounting bracket 662 defines (one or more) at least one aperture 664 and (one or more) at least one opening 666 that is configured to receive (one or more) at least one mechanical fastener 668 (e.g., screw(s), pin(s), rivet(s), etc.)

The alignment member(s) 636 and the boss(es) 638 extend laterally inwardly from the inner side wall 644 of the front housing 600 (e.g., in generally orthogonal relation to the optical axes Xi, Xii (FIG. 3) and the depth D (FIG. 5) of the image capture apparatus 500). More specifically, in the illustrated embodiment, the alignment member(s) 636 include post(s) 670 that are configured for insertion into the aperture(s) 664 in the mounting bracket 662 to guide the mounting bracket 662 during connection of the speaker assembly 658 to the front housing 600, and the boss(es) 638 are configured to receive the mechanical fastener(s) 668 such that the mechanical fastener(s) 668 extend though the mounting bracket 662 and into the boss(es) 638 to thereby connect (secure) the speaker assembly 658 to the front housing 600.

In the illustrated embodiment, the mounting bracket 662 includes a pair of apertures 664i, 664ii, and a single opening 666. Correspondingly, the front housing 600 includes a pair of posts 670i, 670ii, and a single boss 638. It should be appreciated, however, that the particular number of apertures 664, openings 666, posts 670, and bosses 638 may be altered in various embodiments without departing from the scope of the present disclosure. As such, embodiments of the speaker assembly 658 including greater and fewer numbers of apertures 664 and openings 666, and embodiments of the front housing 600 including greater and fewer numbers of posts 670 and bosses 638 are also envisioned herein and would not be beyond the scope of the present disclosure.

The receptacle 640 extends into (e.g., through) the inner side wall 644 of the front housing 600 and is configured to receive (accommodate) the operational button 620ii (FIG. 5). More specifically, as seen in FIG. 10, the receptacle 640 is positioned (located) between the antenna mount 626 and the pocket 628 in generally adjacent relation to, and vertically below, the speaker assembly 658.

The mount 642 is defined by (formed in) the bottom wall 648 of the front housing 600 and includes a plurality (series) of apertures 672i, 672ii, and a receptacle 674.

The apertures 672i are configured to receive a plurality (series) of mechanical fasteners 676i (e.g., screws, pins, rivets, etc.) (FIG. 11), and the apertures 672ii are configured to receive a plurality (series) of mechanical fasteners 676ii. The mechanical fasteners 676i extend through the apertures 672i and into the interconnect mechanism 140 (FIGS. 1B, 11, 19), thereby directly connecting the interconnect mechanism 140 to the front housing 600 in either a fixed or removable fashion, and the mechanical fasteners 676ii extend through the apertures 672ii, through the front internal heat sink 814 (FIGS. 7-9, 17), and into (threaded) engagement with the rear internal heat sink 816 (FIGS. 7, 8, 15, 18) in order to mechanically connect (secure) the heat sinks 814, 816 to each other and to the front housing 600, as described in further detail below.

In order to inhibit (if not entirely prevent) water and/or debris from entering the image capture apparatus 500 through the front housing 600 (e.g., via the apertures 672i, 672ii), the image capture apparatus 500 includes a plurality (series) of seals 678i (e.g., O-rings) (FIGS. 12, 13) that are configured to receive the mechanical fasteners 676i, and a plurality (series) of seals 678ii (e.g., O-rings) that are configured to receive the mechanical fasteners 676ii.

The receptacle 674 (FIG. 10) extends into the mount 642 and is configured to (removably) receive and engage an accessory (e.g., a tripod) (not shown) so as to provide an interface between the image capture apparatus 500 and the accessory. More specifically, the receptacle 674 includes internal threading that is configured in correspondence with external threading on the accessory, which facilitates threaded engagement of the accessory with the interconnect mechanism 140 (FIGS. 1, 11, 19) such that the accessory is directly and removably connectable to the image capture apparatus 500.

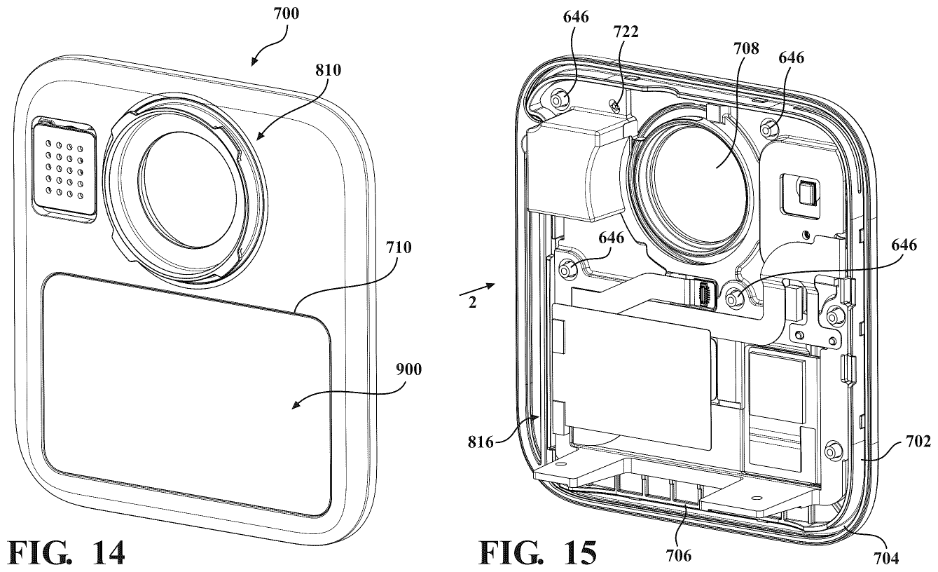

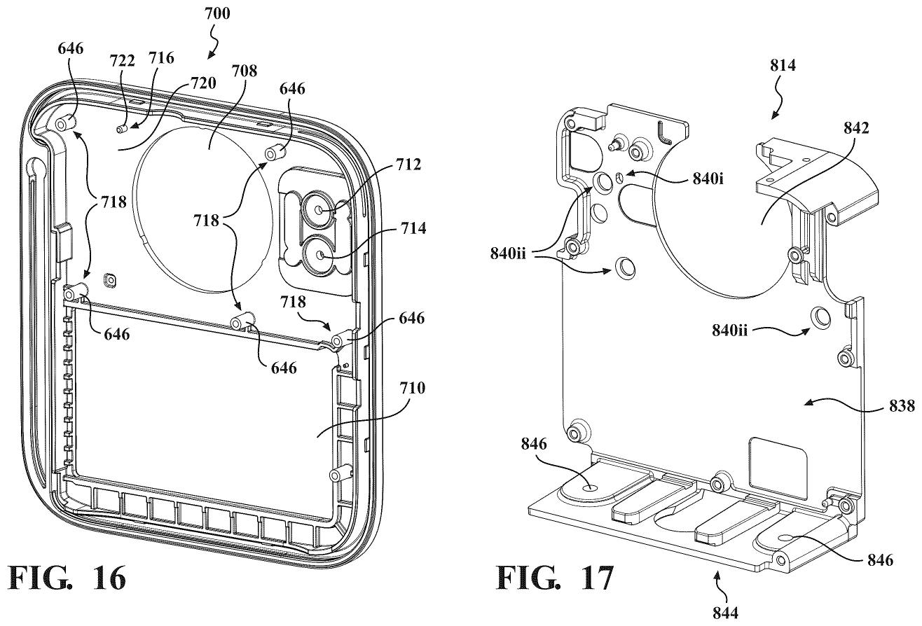

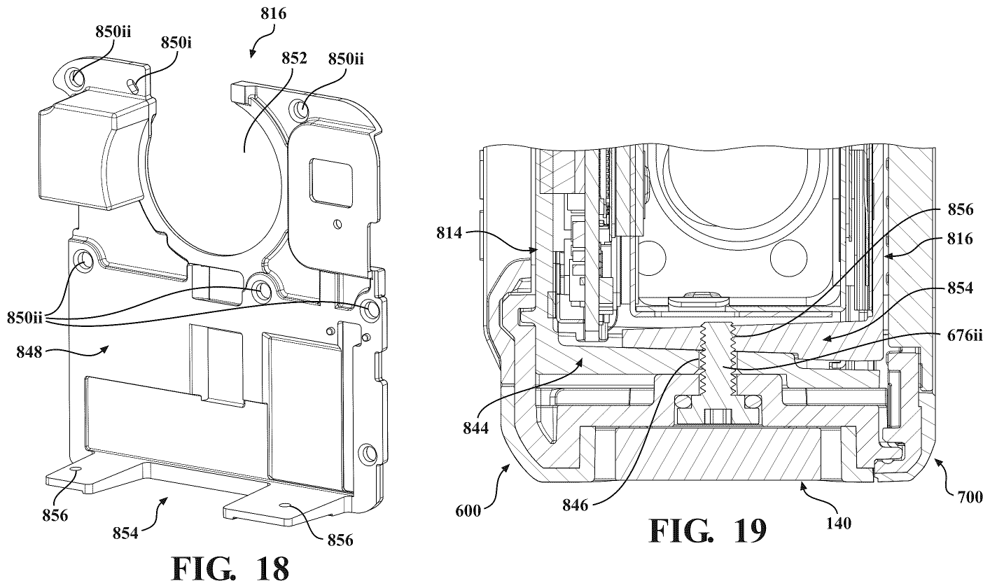

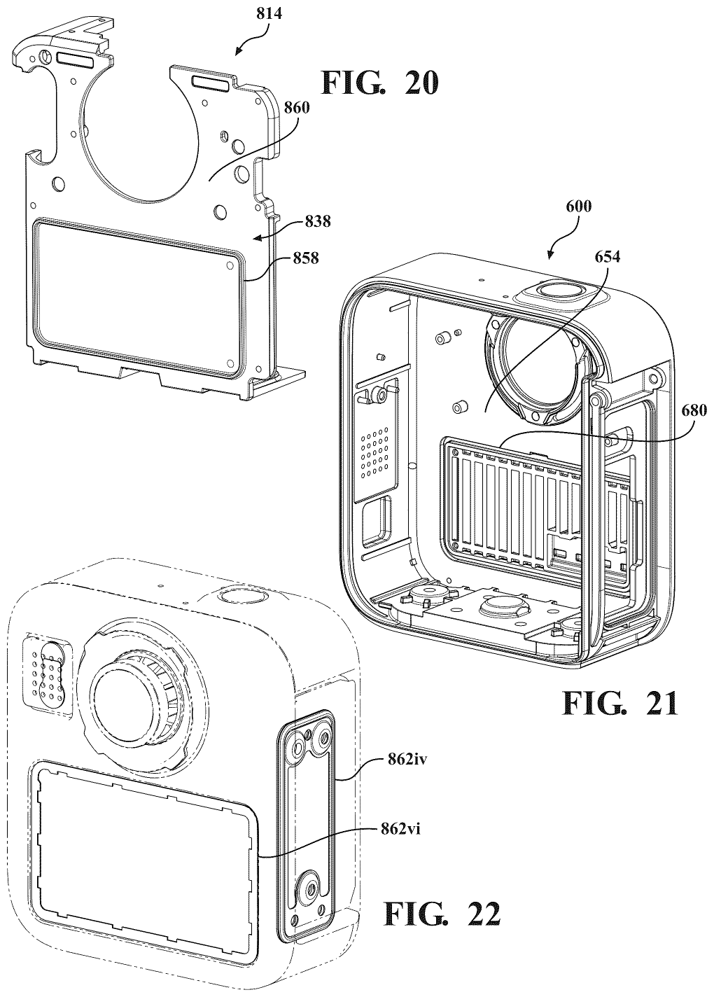

With reference now to FIGS. 14-21, the rear housing 700 and the internal components 800 will be discussed. More specifically, FIG. 14 is a rear, perspective view of the rear housing 700; FIG. 15 is a front, perspective view of the rear housing 700 and the rear internal heat sink 816; FIG. 16 is a front, perspective view of the rear housing 700 with the rear internal heat sink 816 removed; FIG. 17 is a rear, perspective view of the front internal heat sink 814; FIG. 18 is a front, perspective view of the rear internal heat sink 816; FIG. 19 is an enlargement of the area of detail identified in FIG. 7; FIG. 20 is a front, perspective view of the front internal heat sink 814 illustrating sealing to the front housing 600; and FIG. 21 is a rear, perspective view of the front housing 600 illustrating sealing to the front internal heat sink 814.

The rear housing 700 is connected (secured) to the front housing 600 so as to form a watertight seal therebetween. More specifically, the rear housing 406 includes a flange 702 that is spaced inwardly from a perimeter thereof so as to define a recess (groove) 704 (FIG. 15) that is configured in correspondence with the tongue 606 (FIGS. 9, 10) extending form the front housing 600. The recess 704 is configured to receive the tongue 606 such that the housings 600, 700 are connectable (securable) in a tongue-and-groove fashion. To enhance the connection between the housings 600, 700 and further facilitate the formation of a watertight seal therebetween, it is envisioned that an adhesive may be applied to the tongue 606 and/or to the recess 704 prior to connection of the housings 600, 700.

In the illustrated embodiment, the flange 702 includes a non-uniform configuration. More specifically, as seen in FIG. 15, the flange 702 includes a cutout 706, which creates clearance for the interconnect mechanism 140 (FIGS. 1, 11, 19) during assembly of the image capture apparatus 500.

The rear housing 700 supports various thermal and electrical components of the image capture apparatus 500 (e.g., circuitry and electronics supporting the operation and functionality thereof). For example, it is envisioned that the rear housing 700 may include one or more flexible printed circuits (FPCs), electrical connectors, one or more conductive elements to facilitate grounding of the rear housing 700, etc.

The rear housing 700 defines a rear opening 708, and a relief 710, which is spaced vertically from the rear opening 708. Additionally, the rear housing 700 includes: a (microphone) port 712 (FIG. 16) for (one or more) at least one (additional) audio component of the image capture apparatus 500; a vent 714, which facilitates pressure equalization within the image capture apparatus 500; (one or more) at least one registration member 716; and a plurality (series) of supports 718, which are configures as heat stakes 646.

The rear opening 708 extends through the rear housing 700 and is configured to receive the rear mounting member 808. More specifically, the rear mounting member 808 is adhesively connected (secured) to the rear housing 700 within the rear opening 708, which obviates the need for any mechanical connection therebetween.

The relief 710 extends (partially) into the rear housing 700 (e.g., towards the front housing 600), and is configured to receive a display 900. Although shown as being generally rectangular in configuration in the illustrated embodiment, it should be appreciated that the specific configuration of the relief 710 may be varied in alternate embodiments of the disclosure (e.g., depending upon the specific configuration of the display 900).

The registration member(s) 716 and the supports 718 each extend inwardly from an inner face 720 of the rear housing 700 (e.g., in generally parallel relation to the optical axes Xi, Xii (FIG. 3)), and facilitate proper alignment (positioning) and connection of the rear housing 700 and the rear internal heat sink 816 (FIGS. 7, 8, 15, 18).

The registration member(s) 716 include pin(s) 722 that are configured for engagement with the rear internal heat sink 816 (FIGS. 7, 8, 15, 18), as described in further detail below, and are oriented along the depth D (FIG. 5) of the image capture apparatus 500, which facilitates connection of the rear internal heat sink 816 to the rear housing 700 in a rearward (rear) direction 2 (FIG. 15) (e.g., away from the front housing 600).

Although shown as including a registration member 716, it should be appreciated that the particular number of registration members 716 may be altered in various embodiments without departing from the scope of the present disclosure. As such, embodiments of the rear housing 700 including a greater number of registration members 716 (e.g., two or more) are also envisioned herein, and would not be beyond the scope of the present disclosure.

The front mounting member 802 (FIGS. 5, 8) supports a front cover 818 (FIG. 7) and is directly connected (secured) to the front ISLA 806. More specifically, as seen in FIG. 8, the front mounting member 802 defines an opening 820, which is configured to receive the front ISLA 806, and (one or more) at least one aperture 822, which is configured to receive (one or more) at least one mechanical fastener 824 (e.g., screws, pins, rivets, etc.) such that the mechanical fastener(s) 824 extend through the front mounting member 802 and into the front ISLA 806 in order to mechanically connect (secure) the front ISLA 806 to the front mounting member 802.

In order to inhibit (if not entirely prevent) water and/or debris from entering the image capture apparatus 500 through the front mounting member 802 (e.g., via the aperture(s) 822), the image capture apparatus 500 includes (one or more) at least one seal 826 (FIG. 8) (e.g., O-ring(s)) that are configured to receive the mechanical fastener(s) 824.

The front ISLA 806 is positioned (located) within, and extends through, the front housing 600 and the front mounting member 802 (e.g., via the opening 820). In order to inhibit (if not entirely prevent) water and/or debris from entering the image capture apparatus 500 through the front housing 600 and/or the front mounting member 802, the front ISLA 806 includes a front seal 828 (FIG. 8) (e.g., an O-ring) that is configured for engagement (contact) with the front mounting member 802.

The rear mounting member 808 (FIGS. 6-8) defines an opening 830, which is configured to receive the rear ISLA 812, and supports a rear cover 832 (FIG. 7). In contrast to the arrangement between the front mounting member 802 and the front ISLA 806, the rear mounting member 808 and the rear ISLA 812 are devoid of any direct connection therebetween, which allows for relative movement (e.g., floating) between the rear mounting member 808 and the rear ISLA 812.

The rear ISLA 812 is connected (secured) to the front ISLA 806, whereby the ISLAs 806, 812 collectively describe an optical module 834 (FIG. 8) for the image capture apparatus 500. The rear ISLA 812 is positioned (located) within, and extends through, the rear housing 700 and the rear mounting member 808 (e.g., via the opening 830). In order to inhibit (if not entirely prevent) water and/or debris from entering the image capture apparatus 500 through the rear housing 700 and/or the rear mounting member 808, the rear ISLA 812 includes a rear seal 836 (e.g., an O-ring) that is configured for engagement (contact) with the rear mounting member 808.

The front internal heat sink 814 (FIG. 17) is fixedly connected (secured) to the front housing 600 and includes a body portion 838 defining a plurality (series) of apertures 840 and an opening 842, and a lower flange 844.

The apertures 840 are configured to receive the guides 634 (FIG. 10) extending inwardly from the inner face 654 of the front housing 600. More specifically, the front internal heat sink 814 includes (one or more) at least one aperture 840i, which is configured to receive the guide(s) 634i (e.g., the pin(s) 656), and a plurality (series) of apertures 840ii, which are configured to receive the guide(s) 634ii (e.g., the heat stakes 646). As discussed in further detail below, during assembly of the image capture apparatus 500, upon the application of sufficient heat, the front internal heat sink 814 is heat staked to the front housing 600 (e.g., via the guide(s) 634ii).

The opening 842 is generally aligned with the front opening 612 (FIG. 10) in the front housing 600 and is configured to receive the front ISLA 806 such that the front ISLA 806 extends through the front internal heat sink 814.

The lower flange 844 extends rearwardly from the body portion 838 (e.g., towards the rear housing 700), and defines a pair of apertures 846. The apertures 846 are non-threaded and are configured to receive the mechanical fasteners 676ii (FIGS. 7, 11) such that the mechanical fasteners 676ii extend through the front housing 600 (e.g., the mount 642) and through the front internal heat sink 814.

The rear internal heat sink 816 (FIG. 18) is formed as an additional, independent component of the image capture apparatus 500 that is separate from the front internal heat sink 814. The rear internal heat sink 816 is fixedly connected (secured) to the rear housing 700 and includes a body portion 848 defining a plurality (series) of apertures 850 and an opening 852, and a lower flange 854.

The apertures 850 are configured to receive the registration member(s) 716 and the supports 718 extending inwardly from the inner face 720 of the rear housing 700. More specifically, the rear internal heat sink 816 includes (one or more) at least one aperture 850i, which is configured to receive the registration member(s) 716 (e.g., the pin(s) 722), and a plurality (series) of apertures 850ii, which are configured to receive the supports 718 (e.g., the heat stakes 646). As discussed in further detail below, during assembly of the image capture apparatus 500, upon the application of sufficient heat, the rear internal heat sink 816 is heat staked to the rear housing 700 (e.g., via the supports 718).

The opening 852 is generally aligned with the rear opening 708 (FIG. 16) in the rear housing 700 and is configured to receive the rear ISLA 812 such that the rear ISLA 812 extends through the rear internal heat sink 816.

The lower flange 854 extends forwardly from the body portion 848 (e.g., towards the front housing 600), and defines a pair of threaded apertures 856, which are configured to receive the mechanical fasteners 676ii (FIGS. 7, 11, 19). More specifically, the front internal heat sink 814 and the rear internal heat sink 816 are configured such that, upon assembly of the image capture apparatus 500, the lower flanges 844, 854 are in arranged in overlapping, contacting relation, as seen in FIG. 19, which creates a thermal bridge between that allows for the transfer of heat between the internal heat sinks 814, 816, and aligns the apertures 846 with the apertures 856. Alignment of the apertures 846, 856 allows for insertion of the mechanical fasteners 676ii through the front housing 600 (e.g., the mount 642 (FIG. 10)) via the apertures 672ii, through the front internal heat sink 814 via the apertures 846, and into threaded engagement with the rear internal heat sink 816 via the apertures 856. Thus, in addition to being heat staked to the front housing 600 and the rear housing 700, respectively, the heat sinks 814, 816 are mechanically connected (secured) to each other and to the front housing 600 (e.g., via the mechanical fasteners 676ii).

So as not to interfere with connection of the interconnect mechanism 140 (FIGS. 1, 11, 19) to the front housing 600, each of the apertures 672ii, 846, and 856 is spaced laterally outward thereof.

In certain embodiments, such as that illustrated throughout the figures, in addition to being heat staked and mechanically to the front housing 600, it is envisioned that the front internal heat sink 814 may be adhesively connected (secured) to the front housing 600. More specifically, with reference to FIGS. 20 and 21, the body portion 838 of the front internal heat sink 814 includes a tongue 858 that extends from a forward (front) face 860 thereof, which is configured for insertion into a corresponding recess (groove) 680 (FIGS. 10, 21) that is defined by the inner face 654 of the front housing 600, which extends about the front window 614.

During assembly of the image capture apparatus 500, an adhesive is applied to the tongue 858 and/or to the recess 680, which not only further connects (secures) the front housing 600 and the front internal heat sink 814, but also facilitates the formation of a watertight seal therebetween that extends about the front window 614.

With reference now to FIGS. 5, 9, 10, 12 and 22, to further enhance sealing, it is envisioned that the image capture apparatus 500 may include various supplemental seals 862, which may include (e.g., may be formed from) any suitable material or combination of materials, such as a foam, silicone, one or more polymeric materials, a pressure-sensitive adhesive, a heat-activated film, etc. More specifically, FIG. 22 is a rear, perspective view of the image capture apparatus 500 shown in phantom (dashed line) and illustrating sealing of the image capture apparatus 500.

The supplemental seals 862 include: a plurality (series) of seals 862i that are configured to form watertight seal(s) about one or more audio components (e.g., top, front, and/or rear microphones); a seal 862ii that is configured to form a watertight seal about the light pipe 622 (FIG. 5); a seal 862iii that is configured to form a watertight seal about the speaker assembly 658 (FIG. 9), which is supported by the alignment member(s) 636 (e.g., the post(s) 670) (FIG. 10); a seal 862iv that is configured to form a watertight seal with the door 114 (FIGS. 1A, 1B); a seal 862v that is configured to form a watertight seal about the vent 714 in the rear housing 700; and a seal 862vi that is configured to form a watertight seal about the display 900.

With reference now to FIGS. 5-19, a method of assembling the image capture apparatus 500 will be discussed. The method includes: guiding the first antenna into the front housing 600 via the locating member(s) 630 (FIG. 10); connecting (securing) (e.g., heat staking) the first antenna to the front housing 600 via the antenna mount 626; guiding the second antenna into the front housing 600 via the locating member(s) 632 such that the second antenna is positioned (located) within the pocket 628 vertically below the first antenna; (adhesively) connecting (securing) the second antenna to the front housing 600 within the pocket 628; inserting the operational button 620ii (FIG. 5) into the receptacle 640 (FIG. 10) such that the operational button 620ii is positioned (located) between the antenna mount 626 and the pocket 628; inserting the alignment member(s) 636 into the aperture(s) 664 (FIG. 9) that are defined by the mounting bracket 662 of the speaker assembly 658; inserting the mechanical fastener(s) 668 through the opening(s) 666 that are defined by the mounting bracket 662 and into the boss(es) 638 to thereby connect (secure) the speaker assembly 658 to the front housing 600; inserting the front mounting member 802 (FIG. 8) into the front opening 612 in the front housing 600; (adhesively) connecting (securing) the front mounting member 802 to the front housing 600; inserting the rear mounting member 808 (FIG. 8) into the rear opening 708 in the rear housing 700; (adhesively) connecting (securing) the rear mounting member 808 to the rear housing 700; inserting the guides 634 (FIG. 10) on the front housing 600 into the apertures 840 (FIG. 17) that are defined by the front internal heat sink 814; connecting (securing) (e.g., heat staking and adhesively connecting (securing)) the front internal heat sink 814 to the front housing 600; inserting the registration member(s) 716 (FIG. 16) and the supports 718 on the rear housing 700 into the apertures 850 (FIG. 18) that are defined by the rear internal heat sink 816; connecting (securing) (e.g., heat staking) the rear internal heat sink 816 to the rear housing 700; inserting the front ISLA 806 (FIG. 8) through the opening 842 (FIG. 8) in the body portion 838 of the front internal heat sink 814; positioning the front ISLA 806 within the front mounting member 802 such that the front seal 828 engages (contacts) the front mounting member 802; mechanically connecting (securing) the front ISLA 806 to the front mounting member 802 (e.g., via the mechanical fastener(s) 824; inserting the rear ISLA 812 through the opening 852 in the body portion 848 of the rear internal heat sink 816; positioning the rear ISLA 812 within the rear mounting member 808 such that the rear seal 836 engages (contacts) the rear mounting member 808; mechanically connecting (securing) the heat sinks 814, 816 to front housing 600 by inserting the mechanical fasteners 676ii (FIGS. 7, 11, 19) through the front housing 600 (via the apertures 672ii (FIG. 10)), through the front internal heat sink 814 (e.g., via the apertures 846 (FIGS. 17, 19)), and into the rear internal heat sink 816 (e.g., via the apertures 856 (FIGS. 18, 19)); mechanically connecting (securing) the front internal heat sink 814 and the rear internal heat sink 816 to the front housing 600 (e.g., via the mechanical fasteners 676ii); connecting (securing) the interconnect mechanism 140 (FIGS. 1, 11, 19) to the front housing 600 (e.g., via the mechanical fasteners 676i); inserting the tongue 606 (FIGS. 9, 10) defined the front housing 600 into the recess 704 (FIG. 15) defined by the rear housing 700; and adhesively connecting (securing) the front housing 600 and the rear housing 700 so as to form a watertight seal therebetween.

While the present disclosure has been described in connection with certain embodiments, it is to be understood that the present disclosure is not to be limited to the disclosed embodiments, but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “generally,” “approximately,” “substantially,” and the like should be understood to include the numerical range, concept, or base term with which they are associated as well as variations in the numerical range, concept, or base term on the order of up to 25% (e.g., to allow for manufacturing tolerances and/or deviations in design). For example, the term “generally parallel” should be understood as referring to an arrangement in which the pertinent components (structures, elements) subtend an angle therebetween that is equal to 1800 as well as an arrangement in which the pertinent components (structures, elements) subtend an angle therebetween that is greater than or less than 180° (e.g., ±10%, +15%, ±25%). The term “generally parallel” should thus be understood as encompassing configurations in which the pertinent components are arranged in parallel relation. Similarly, the term “generally identical” should be understood as encompassing configurations in which the pertinent components are identical in configuration as well as configurations in which there may be insubstantial variations between the pertinent components that do not influence the substantive construction or performance thereof.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure, etc.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An image capture apparatus comprising:
a front housing defining a front opening and a front window spaced vertically from the front opening, wherein the front housing includes:
an antenna mount configured for connection to a first antenna;
a first locating member configured for engagement with the first antenna to guide the first antenna during connection to the front housing;
a pocket configured to receive a second antenna;
a second locating member configured for engagement with the second antenna to guide the second antenna during connection to the front housing;
a speaker assembly connected to an inner side wall of the front housing, wherein the speaker assembly includes:
a speaker; and
a mounting bracket defining:
at least one aperture; and
at least one opening configured to receive at least one mechanical fastener;
at least one alignment member configured for insertion into the at least one aperture in the mounting bracket to guide the mounting bracket during connection of the speaker assembly to the front housing; and
at least one boss configured to receive the at least one mechanical fastener to thereby connect the speaker assembly to the front housing;
a front mounting member connected to the front housing and located within the front opening;
a front integrated sensor-lens assembly (ISLA) that extends through the front mounting member and mechanically connected thereto;
a rear housing defining a rear opening and a relief spaced vertically from the rear opening, wherein the rear housing is connected to the front housing so as to form a watertight seal therebetween;
a rear mounting member connected to the rear housing and located within the rear opening; and
a rear ISLA extending through the rear mounting member such that the image capture apparatus is devoid of any direct connection between the rear mounting member and the rear ISLA.

2. The image capture apparatus of claim 1, wherein the front mounting member is adhesively connected to the front housing, and wherein the rear mounting member is adhesively connected to the rear housing.

3. The image capture apparatus of claim 1, further comprising:
a front internal heat sink connected to the front housing; and
a rear internal heat sink connected to the rear housing.

4. The image capture apparatus of claim 3, wherein the front internal heat sink is heat staked to the front housing, and wherein the rear internal heat sink is heat staked to the rear housing.

5. The image capture apparatus of claim 3, further comprising:
mechanical fasteners extending through the front housing, through the front internal heat sink, and into threaded engagement with the rear internal heat sink.

6. An image capture apparatus comprising:
a front housing defining a front opening;
a front mounting member located within the front opening;
a front integrated sensor-lens assembly (ISLA) mechanically connected to and extending through the front mounting member;
a front internal heat sink connected to the front housing;
a rear housing defining a rear opening and connected to the front housing so as to form a watertight seal therebetween;
a rear mounting member located within the rear opening;
a rear ISLA extending through the rear mounting member such that the image capture apparatus is devoid of any direct connection between the rear mounting member and the rear ISLA; and
a rear internal heat sink connected to the rear housing.

7. The image capture apparatus of claim 6, wherein the front mounting member is adhesively connected to the front housing, and wherein the rear mounting member is adhesively connected to the rear housing.

8. The image capture apparatus of claim 6, wherein the front ISLA includes a front seal configured for engagement with the front mounting member to inhibit water and/or debris from entering the image capture apparatus through the front housing and/or through the front mounting member, and wherein the rear ISLA includes a rear seal configured for engagement with the rear mounting member to inhibit water and/or debris from entering the image capture apparatus through the rear housing and/or through the rear mounting member.

9. The image capture apparatus of claim 6, further comprising:
a speaker assembly connected to an inner side wall of the front housing.

10. The image capture apparatus of claim 9, wherein the speaker assembly includes:
a speaker; and
a mounting bracket supporting the speaker.

11. The image capture apparatus of claim 10, wherein the front housing includes:
at least one alignment member extending from the inner side wall and configured for insertion into the mounting bracket to guide the speaker assembly during connection to the front housing; and
at least one boss extending from the inner side wall and configured to receive at least one mechanical fastener such that the at least one mechanical fastener extends through the mounting bracket and into the at least one boss to thereby connect the speaker assembly to the front housing.

12. The image capture apparatus of claim 6, wherein the front internal heat sink and the rear internal heat sink are mechanically connected to the front housing.

13. The image capture apparatus of claim 12, wherein the front internal heat sink includes first apertures, the rear internal heat sink includes second apertures, and the front housing includes third apertures, and wherein the first apertures, the second apertures, and the third apertures are configured to receive mechanical fasteners such that the mechanical fasteners extend through the front housing, through the front internal heat sink, and into threaded engagement with the rear internal heat sink.

14. The image capture apparatus of claim 13, further comprising:
an interconnect mechanism configured for engagement with an accessory to thereby connect the image capture apparatus to the accessory.

15. The image capture apparatus of claim 14, wherein the first apertures, the second apertures, and the third apertures are spaced laterally outward of the interconnect mechanism.

16. A method of assembling an image capture apparatus that includes a front housing having an inner side wall and an antenna mount and a pocket associated with the inner side wall, the method comprising:
inserting an operational button into a receptacle extending into the inner side wall, wherein the receptacle is positioned between the antenna mount and the pocket;
connecting a speaker assembly to the inner side wall;
connecting a front mounting member to the front housing;
positioning a front integrated sensor-lens assembly (ISLA) within the front mounting member;
connecting a rear mounting member to a rear housing of the image capture apparatus;
positioning a rear ISLA within the rear mounting member; and
adhesively connecting the front housing and the rear housing so as to form a watertight seal therebetween,
wherein the antenna mount is configured for connection to a first antenna, and
wherein the pocket is configured to receive a second antenna such that the second antenna is positioned vertically below the first antenna.

17. The method of claim 16, wherein connecting the speaker assembly to the inner side wall includes:
inserting at least one alignment member extending laterally inward from the inner side wall into at least one aperture defined by a mounting bracket of the speaker assembly; and
inserting at least one mechanical fastener through at least one opening in the mounting bracket and into at least one boss on the inner side wall.

18. The method of claim 16, further comprising:
connecting a front internal heat sink to the front housing; and
connecting a rear internal heat sink to the rear housing.

19. The method of claim 18, wherein connecting the front internal heat sink to the front housing includes heat staking the front internal heat sink to the front housing, and wherein connecting the rear internal heat sink to the rear housing includes heat staking the rear internal heat sink to the rear housing.

20. The method of claim 18, further comprising:
inserting mechanical fasteners through the front housing, through the front internal heat sink, and into threaded engagement with the rear internal heat sink to thereby mechanically connect the front internal heat sink and the rear internal heat sink to the front housing.
